(19) United States
(12) Patent Application Publication
(10) Pub. No.: US 2008/0204121 A1
(43) Pub. Date: Aug. 28, 2008

(54) Voltage generating circuit having charge pump and liquid crystal display using same

(75) Inventors: Shun-Ming Huang, Shenzhen (CN); Chien-Fan Tung, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO.; INNOLUX DISPLAY CORP.

(21) Appl. No.: 12/072,837

(22) Filed: Feb. 28, 2008

(30) Foreign Application Priority Data
Feb. 28, 2007 (CN) 200710073412.8

(51) Int. Cl. G05F 3/02; G09G 3/36

(52) U.S. Cl. 327/536; 345/87

(57) ABSTRACT

An exemplary voltage generating circuit (34) includes a first pulse generator (341) configured to provide a first pulse signal having a fixed duty ratio, a second pulse generator (342) configured to provide a second pulse signal having a variable duty ratio, and a charge pump (343) electrically coupled to the first pulse generator and the second pulse generator. The charge pump outputs a voltage signal according to the first and second pulse signals. When the voltage signal is adjusted, the duty ratio of the second pulse signal is modulated by the second pulse generator, such that the voltage signal outputted by the charge bump is adjusted to have a corresponding value. A liquid crystal display (300) using the voltage generating circuit is also provided in the present invention.

### FIELD OF THE INVENTION

The present invention relates to voltage generating circuits, and more particularly to a voltage generating circuit having a charge pump. The present invention also relates to a liquid crystal display (LCD) using the voltage generating circuit.

### GENERAL BACKGROUND

LCDs are widely used in various modern information products, such as notebooks, personal digital assistants, video cameras and the like. In general, an LCD usually includes a voltage generating circuit, and the voltage generating circuit is used for providing a common voltage for the LCD.

Referring to FIG. 4, a conventional voltage generating circuit 20 used in an LCD is shown. The voltage generating circuit 20 includes a controller 210, a plurality of resistors 220, and a plurality of switches 230. The resistors 220 are electrically coupled in series, and cooperatively constitute a resistor-string. The resistor-string serves as a voltage divider. A power voltage Vdd is applied to one end of the resistor-string, and the other end of the resistor-string is grounded.

The controller 210 includes a plurality of input terminals 211 and a plurality of output terminals 212. Each of the input terminals 211 is used to receive a digital code. Each of the output terminals 212 is used to output a control signal. The switch 230 includes a control end (not labeled), a first end (not labeled), and a second end (not labeled). Each control end is electrically coupled to a respective output terminal 212 of the controller 210. Each of the first ends is electrically coupled to a respective node 223 between two adjacent coupled resistors 220. All the second ends are electrically coupled to a voltage output terminal 231. The voltage output terminal 231 is configured to provide a common voltage for a liquid crystal panel (not shown) of the LCD.

In operation, the power voltage Vdd generates a current, and causes the current to flow through the resistors 220 sequentially. Due to the current, each resistor 220 generates a bias voltage. Thereby, the power voltage Vdd is divided into a plurality of sub-voltages, each of which is applied to the first end of the corresponding switch 230 via the corresponding node 223. The controller 210 receives a plurality of digital codes via the input terminals 211, and generates a plurality of control signals according to the digital codes. In particular, only one of the control signals has a high level voltage, and the others all have low level voltages. The control signals are then applied to the corresponding control ends of the switches 230. Thereby, the switch 230 corresponding to the high level voltage is turned on, and the other switches 230 are all turned off. In this situation, the corresponding one of the sub-voltage is selected and transmitted to the voltage output terminal 231 via the on-state switch 230. The selected sub-voltage serves as a common voltage, and is outputted to the liquid crystal panel.

When the digital codes received by the controller 210 change, the common voltage correspondingly changes to another sub-voltage. That is, the common voltage can be adjusted to have a desired value via applying corresponding digital codes. Moreover, the digital codes can in turn be generated according to an instruction signal from a user.

However, due to the numerous resistors 220, the voltage generating circuit 20 is large and complicated. In addition, because the common voltage is generated and adjusted via the voltage divider, a precision of the voltage adjusting depends on the total amount of resistors 220. The total amount of resistors 220 is finite, thus the precision of voltage adjusting is limited. When the common voltage provided via such low precision adjusting in the voltage generating circuit 20 is applied to the LCD, the display quality of the LCD may be low.

It is, therefore, needed to provide a voltage generating circuit and an LCD using the voltage generating circuit that can overcome the above-described deficiencies.

### SUMMARY

In one aspect, a voltage generating circuit includes a first pulse generator configured to provide a first pulse signal having a fixed duty ratio, a second pulse generator configured to provide a second pulse signal having a variable duty ratio, and a charge pump electrically coupled to the first pulse generator and the second pulse generator. The charge pump outputs a voltage signal according to the first and second pulse signals. When the voltage signal is adjusted, the duty ratio of the second pulse signal is modulated by the second pulse generator, such that the voltage signal outputted by the charge bump is adjusted to have a corresponding value.

In another aspect, a liquid crystal display includes a liquid crystal panel having a plurality of pixels, and a voltage generating circuit configured to provide a common voltage signal for the pixels. The voltage generating circuit includes a first pulse generator, a second generator, and a charge pump. The charge pump receives a first pulse signal having a fixed duty ratio from the first pulse generator, and receives a second pulse signal having a variable duty ratio from the second pulse generator, and then outputs a common voltage signal to the pixels according to the first and second pulse signals. A value of the common voltage signal is adjusted when the duty ratio of the second pulse signal is modulated.

Other novel features and advantages will become more apparent from the following detailed description when taken in conjunction with the accompanying drawings, in which:

### BRIEF DESCRIPTION OF THE DRAWINGS

FIG. 1 is an abbreviated circuit diagram of an LCD according to an exemplary embodiment of the present invention, the LCD including a voltage generating circuit.

FIG. 2 is a circuit diagram of the voltage generating circuit of the LCD of FIG. 1.

FIG. 3 is a timing chart of pulse signals transmitting in the voltage generating circuit.

FIG. 4 is an abbreviated circuit diagram of a conventional voltage generating circuit typically used in an LCD.

### DETAILED DESCRIPTION OF PREFERRED EMBODIMENTS

Reference will now be made to the drawings to describe preferred and exemplary embodiments of the present invention in detail.

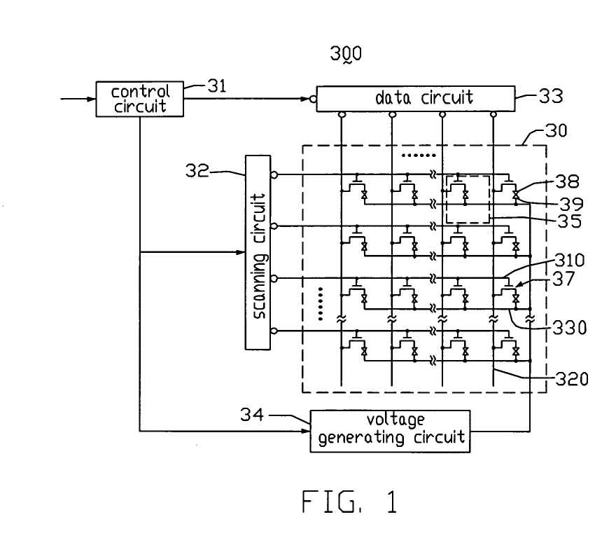

Referring to FIG. 1, an LCD 300 according to an exemplary embodiment of the present invention is shown. The LCD 300 includes a liquid crystal panel 30, a control circuit 31, a scanning circuit 32, a data circuit 33, and a voltage generating circuit 34. The scanning circuit 32 and the data circuit 33 are configured to drive the liquid crystal panel 30. The voltage generating circuit 34 is configured to provide a common voltage for the liquid crystal panel 30. The control circuit 31 is configured to control a driving timing of the scanning circuit 32 and the data circuit 33.

The liquid crystal panel 30 includes n rows of parallel scanning lines 310 (where n is a natural number), n rows of parallel common lines 330 alternately disposed between the scanning lines 310, m columns of parallel data lines 320 perpendicular to the scanning lines 310 (where m is also a natural number), and a plurality of pixels 35 cooperatively defined by the crossing scanning lines 310 and data lines 320. Thereby, the pixels 35 are arrayed in a matrix manner, so as to form a so-called active matrix cooperatively. Moreover, the scanning lines 310 are electrically coupled to the scanning circuit 32. The data lines 320 are electrically coupled to the data circuit 33. The common lines 330 are electrically couple to the voltage generating circuit 34.

Each pixel 35 includes a thin film transistor (TFT) 37, a pixel electrode 38, a common electrode 39, and liquid crystal molecules (not labeled) interposed between the pixel electrode 38 and the common electrode 39. The TFT 37 is disposed near an intersection of a corresponding one of the scanning lines 310 and a corresponding one of the data lines 320. A gate electrode of the TFT 37 is electrically coupled to the corresponding one of the scanning lines 310, and a source electrode of the TFT 37 is electrically coupled to the corresponding one of the data lines 320. Further, a drain electrode of the TFT 37 is electrically coupled to the pixel electrode 38. Moreover, the common electrode 39 is electrically coupled to the corresponding one of the common lines 330. Each pixel electrode 332, the corresponding common electrode 334, and the liquid crystal molecules therebetween cooperatively form a liquid crystal capacitor (not labeled).

Referring also the FIG. 2, the voltage generating circuit 34 includes a first pulse generator 341, a second pulse generator 342, and a charge pump 343. The first pulse generator 341 is used to provide a first pulse signal having a fixed duty ratio for the charge pump 343. The second pulse generator 342 is used to provide a second pulse signal having a variable duty ratio for the charge pump 343. The second pulse generator 342 can be a pulse width modulation (PWM) circuit, and a resolution thereof is variable.

The charge pump 343 includes a first input terminal 344, a second input terminal 345, a first capacitor 301, a second capacitor 302, a third capacitor 303, a first resistor 304, a second resistor 305, and a switch member 306. The first input terminal 344 is configured to receive the first pulse signal, and the second input terminal 345 is configured to receive the second pulse signal.

The switch member 306 includes a first diode 307 and a second diode 308. A negative terminal of the first diode 307 is electrically coupled to the first input terminal 344 via the first capacitor 301. A positive terminal of the first diode 307 is electrically coupled to the second input terminal 345 via the first resistor 304, and is grounded via the second capacitor 302. A positive terminal of the second diode 308 is electrically coupled to the negative terminal of the first diode 307. A negative terminal of the second diode 308 is electrically coupled to the output terminal 346 via the second resistor 305. The output terminal 346 is grounded via the third capacitor 303, and is further electrically coupled to the common line 330 of the liquid crystal panel 30.

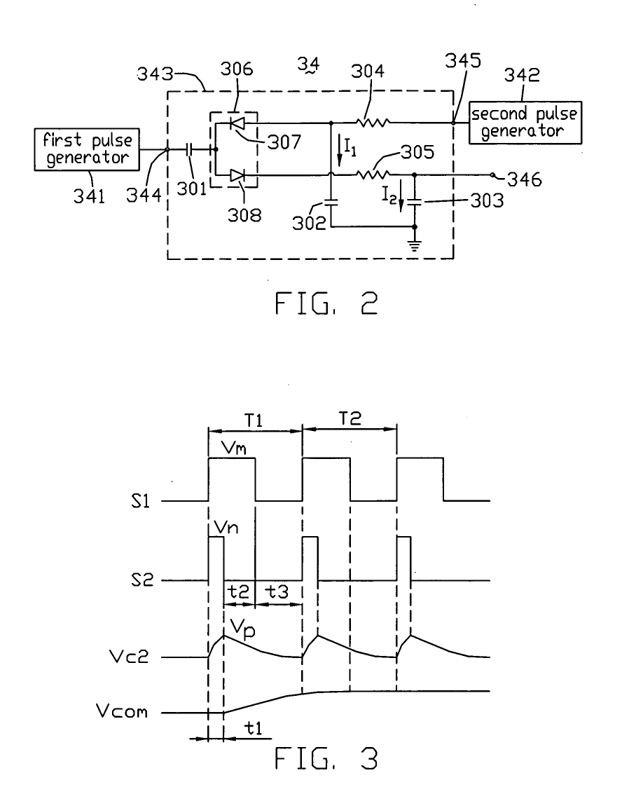

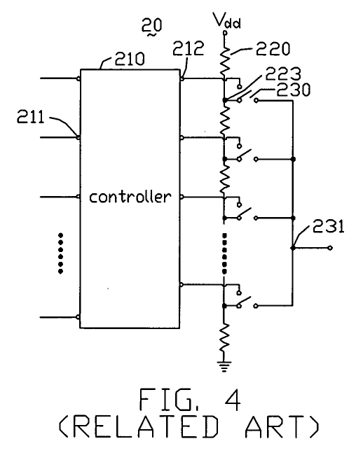

Referring also to FIG. 3, a timing chart of pulse signals transmitting in the voltage generating circuit 34 is shown. In the timing chart, S1 represents the first pulse signal, S2 represents the second pulse signal, Vc2 represents a voltage of the second capacitor 302, and Vcom represents the common voltage outputted by the output terminal 346. A least period of the first pulse signal S1 is the same as that of the second pulse signal S2. Each least period of the first signal S1 can be divided into a first period of time t1, a second period of time t2, and a third period of time t3.

Generally, operation of the voltage generating circuit 34 is as follows. When a first period T1 starts, a first high level Vm is provided to the first pulse signal S1, and simultaneously a second high level voltage Vn is provided to the second pulse signal S2. In this situation, the first diode 307 is switched off, and the common voltage Vcom maintains a primary value. Due to the second high level voltage Vn, a first current I1 is generated and flows to the second capacitor 302 via the first resistor 304. Thereby, the second capacitor 302 is charged and the voltage Vc2 thereof is increased.

After the first period of time t1, the second pulse signal S2 is converted to a low voltage signal (e.g. 0V). Thereby, the charging process is finished, and the voltage Vc2 reaches a peak value Vp. Because the duty ratio of the second pulse signal S2 is variable, the period of time t1 can be controlled as desired. Thereby, the peak value Vp of the voltage Vc2 can be adjusted to have a desired value via modulating the duty ratio of the second pulse signal S2.

When the second the pulse signal S2 drops to the low level voltage, the second capacitor 302 starts to discharge, and the first diode 307 is switched on. A second current 12 is then generated and flows to the third capacitor 303 via the first diode 307, the second diode 308, and the second resistor 305 sequentially. Thus the third capacitor 303 is charged and the voltage thereof is increased. That is, the common voltage Vcom is increased.

After the second period of time t2, the first pulse signal S1 is also converted to a low level voltage. The second current 12 continues to charge the third capacitor 303, such that the common voltage Vcom keeps on increasing. Assuming that voltage drops of the first diode 307 and the second diode 308 are both Vd, the common voltage Vcom is gradually stepped up to a new value about (Vp−2Vd). In particular, the voltage drops Vd of the first diode 307 and the second diode 308 are both slight, and have little influence on the common voltage Vcom.

After the third period of time t3, the first period T1 is finished, and a second period T2 starts sequentially. The first pulse signal S1 and the second pulse signal S2 are respectively converted to the first high level voltage Vm and the second high level voltage Vn again. Due to a so-called coupling effect of the first capacitor 301, the voltage of the positive terminal of the second diode 308 is pulled up to about (Vp+Vm−Vd). This causes the first diode 307 to be switched off, and the second capacitor 302 is charged again because of the second high level voltage Vn. Besides, the third capacitor 303 is charged by the first capacitor 301 via the second diode 308 and the second resistor 305. Thereby, the common voltage Vcom is gradually stepped up from (Vp−2Vd) to (Vp+Vm−2Vd).

After that, the second pulse signal S2 is converted to the low level voltage again. The second capacitor 302 discharges to the third capacitor 303, so as to compensate a decrease of voltage of the third capacitor 303 while providing the common voltage Vcom for the liquid crystal panel 30. Thereby, the common voltage Vcom retains at a value about (Vp+Vm−2Vd).

After the period T2, the common voltage Vcom provided by the output terminal 346 is maintained.

As described above, in the voltage generating circuit 34, the common voltage Vcom eventually reaches to the value about (Vp+Vm−2Vd), and the peak value Vp of the voltage Vc2 can be adjusted via modulating the duty ratio of the second pulse signal S2. Therefore, the common voltage Vcom can be adjusted as desired. In detail, when the duty ratio of the second pulse signal S2 is enlarged, the common voltage Vcom is increased. When the duty ratio of the second pulse signal S2 decreases, the common voltage Vcom is reduced.

Furthermore, a precision of the voltage adjusting of the voltage generating circuit 34 can be set via adjusting a resolution of the second pulse generator 342. For instance, if a precision of 10 mV (millivolts) within a range of voltages spanning 1V is needed, the resolution of the second pulse generator 342 can be set to 7 bits.

In summary, the voltage generating circuit 34 employs the first pulse generator 341, the second pulse generator 342, and the charge bump 343 to provide the common voltage Vcom for the liquid crystal panel 30. The common voltage Vcom can be adjusted via modulating the duty ratio of the second pulse signal S2 provided by the second pulse generator 342. Thus the voltage generating circuit 34 does not need many resistors, and accordingly the voltage generating circuit 34 is simple. Moreover, because the duty ratio of the second pulse signal S2 can be adjusted as desired, a higher precision of the voltage adjusting of the common voltage Vcom can be achieved. Therefore, by employing the voltage generating circuit 34, the display quality of the LCD 300 is improved.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of arrangement of parts) within the principles of the invention to the full extent indicated by the broad general meaning of the terms in which the appended claims are expressed.

What is claimed is:

1. A voltage generating circuit, comprising:
a first pulse generator configured to provide a first pulse signal having a fixed duty ratio;
a second pulse generator configured to provide a second pulse signal having a variable duty ratio; and
a charge pump electrically coupled to the first pulse generator and the second pulse generator;
wherein the charge pump outputs a voltage signal according to the first and second pulse signals, when the voltage signal is adjusted, the duty ratio of the second pulse signal is modulated by the second pulse generator, such that the voltage signal outputted by the charge bump is adjusted to have a corresponding value.

2. The voltage generating circuit as claimed in claim 1, wherein the second pulse generator is a pulse width modulation circuit.

3. The voltage generating circuit as claimed in claim 1, wherein a resolution of the second pulse generator is variable.

4. The voltage generating circuit as claimed in claim 3, wherein the resolution of the second pulse generator is 7 bits.

5. The voltage generating circuit as claimed in claim 1, wherein the charge bump comprises a first input terminal configured to receive the first pulse signal, a second input terminal configured to receive the second pulse signal, and an output terminal configured to output the voltage signal.

6. The voltage generating circuit as claimed in claim 5, wherein the charge bump further comprises a first capacitor, a first diode, and a second diode, a negative terminal of the first diode is electrically coupled to the first input terminal via the first capacitor, a positive terminal of the first diode is electrically coupled to the second input terminal, a positive terminal of the second diode is electrically coupled to the negative terminal of the first diode, and a negative terminal of the second diode is electrically coupled to the output terminal.

7. The voltage generating circuit as claimed in claim 6, wherein the charge bump further comprises a second capacitor, the positive terminal of the first diode is grounded via the second capacitor.

8. The voltage generating circuit as claimed in claim 7, wherein the charge bump further comprises a third capacitor, the negative terminal of the second diode is grounded via the third capacitor.

9. A liquid crystal display, comprising:
a liquid crystal panel comprising a plurality of pixels; and
a voltage generating circuit configured to provide a common voltage signal for the pixels, the voltage generating circuit comprising a first pulse generator, a second generator, and a charge pump;
wherein the charge pump receives a first pulse signal having a fixed duty ratio from the first pulse generator, and receives a second pulse signal having a variable duty ratio from the second pulse generator, and then outputs a common voltage signal to the pixels according to the first and second pulse signals, a value of the common voltage signal is adjusted when the duty ratio of the second pulse signal is modulated.

10. The liquid crystal display as claimed in claim 9, wherein the second pulse generator is a pulse width modulation circuit.

11. The liquid crystal display as claimed in claim 9, wherein a resolution of the second pulse generator is variable.

12. The liquid crystal display as claimed in claim 11, wherein the resolution of the second pulse generator is 7 bits.

13. The liquid crystal display as claimed in claim 9, wherein the charge bump comprises a first input terminal configured to receive the first pulse signal, a second input terminal configured to receive the second pulse signal, and an output terminal configured to output the common voltage signal.

14. The liquid crystal display as claimed in claim 13, wherein the charge bump further comprises a first capacitor, a first diode, and a second diode, a negative terminal of the first diode is electrically coupled to the first input terminal via the first capacitor, a positive terminal of the first diode is electrically coupled to the second input terminal, a positive terminal of the second diode is electrically coupled to the negative terminal of the first diode, and a negative terminal of the second diode is electrically coupled to the output terminal.

15. The liquid crystal display as claimed in claim 14, wherein the charge bump further comprises a second capacitor, the positive terminal of the first diode is grounded via the second capacitor.

16. The liquid crystal display as claimed in claim 15, wherein the charge bump further comprises a third capacitor, the negative terminal of the second diode is grounded via the third capacitor.
